(19) United States
(12) Patent Application Publication
(10) Pub. No.: US 2004/0024620 A1
(43) Pub. Date: Feb. 5, 2004

(54) Risk classification methodology

(75) Inventors: Peter T. Robertson, Auburndale, MA (US); Donald Bashline, Watertown, MA (US); Jason DePasquale, Chicago, IL (US)

Correspondence Address: McDERMOTT, WILL & EMERY, 600 13th Street, N.W., Washington, DC, 20005-3096, US

(73) Assignee: Rightfind Technology Company, LLC

(21) Appl. No.: 10/601,118

(22) Filed: Jun. 23, 2003

Related U.S. Application Data
(63) Continuation-in-part of application No. 09/452,126, filed on Dec. 1, 1999, now abandoned.

(51) Int. Cl. G06F 17/60

(52) U.S. Cl. 705/4; 705/2

(57) ABSTRACT

An insurance risk classification methodology involves classifying prospective insureds into risk groups based on personality traits that determine behavior and are thereby predictive of insurance loss. In one embodiment, a questionnaire is given to the prospective insured to measure personality variables of the prospective insured. Depending on answers to the questions, the prospective insured is classified into an appropriate risk group. In another embodiment, a surveying methodology is used to formulate the questionnaire.

### CROSS-REFERENCE TO RELATED APPLICATION

This application is a continuation-in-part application of U.S. application Ser. No. 09/452,126, filed on Dec. 1, 1999, the contents of which are incorporated herein by reference.

### TECHNICAL FIELD

The present disclosure relates to insurance and, more particularly, to a methodology for risk classification in automobile and other lines of insurance.

### BACKGROUND OF THE DISCLOSURE

Insurers generally divide their customers into various “classifications” to determine an appropriate insurance rate for each customer. For buyers of insurance, an accurate classification helps achieve rate equity, in that a buyer would more likely pay a rate commensurate with his risk relative to other insureds. For sellers of insurance, accurate classifications are necessary to avoid being placed at a competitive disadvantage.

For example, if a life insurer charged the same rate for purchasers of all ages, the inequity of this price structure would encourage younger buyers to migrate to lower priced competition. On the other hand, older purchasers would take advantage of the relative bargain. As a result, even if an appropriate average rate were charged, the life insurer's failure to accurately classify its customers reduces profits by setting rates that are too low for the elderly and too high for the young.

After World War II, the increased availability and use of the automobile has forced automobile insurers to adopt increasingly sophisticated classification plans. An early attempt involved a three class plan wherein different rates were charged for business use, personal use by most people, and personal use by male drivers under twenty-five years of age. The class for males under twenty-five was adopted because the accident frequency for such drivers is much higher than for other drivers.

The homogeneity of a classification is an important criterion for a competitive insurance classification system. A homogeneous class contains risks of similar loss potential and should not have identifiable subsets. If a class is not homogeneous then it may become profitable to subdivide the class into two or more subsets, depending on the cost of the information required to identify the subset to which each member of the subdivided class belongs.

Since the original adoption of the three class plan, personal automobile insurers have progressively refined their classifications adding more categories typically based on easily collected criteria, such as age, gender, marital status, and driving record. For example, young drivers with good grades or who have completed a drivers education class were grouped into a new and less costly class. As another example, married men under twenty-five were classified into a new group because married men under twenty-five were found to have fewer accidents than their single counterparts.

A recent development has been the growth of the nonstandard automobile insurance market, which consists of drivers with worse-than-average driving records. Instead of simply denying these poor drivers insurance, as was common in the past, automobile insurers have come to recognize that there is a wide variation of risk within this group. Due to this lack of homogeneity, there is a need for and a potential for large profits in new methodologies to subdivide this group into more additional risk classifications.

Therefore, insurers are constantly seeking for new ways to refine their classifications to maintain their competitive advantage as conventional classifications become widely adopted in the industry. A modern trend is to access the customer's credit history obtained from companies that collect and maintain databases on consumer buying and credit habits. Use of credit information, however, threatens to create regulatory and legal issues for several reasons, including concerns about a higher incidence of bad credit reports among minorities, about lack of evidence of a causal relationship between bad credit reports and claims reporting, and about increasing intrusions into privacy. Other information may be so costly to collect that it forecloses a proposed classification scheme as unprofitable.

### SUMMARY OF THE DISCLOSURE

The long-felt needs of the insurance industry are addressed by the present disclosure by enabling insurers to refine their classifications using information that has heretofore been inaccessible: information about personality or character traits of the prospective insured that determine behavior that in turn causes insurance loss.

Accordingly, one aspect of the disclosure is a method and software for risk classification for a prospective insured, in which data regarding personality traits of the prospective insured is accessed, and the prospective insured is classified into a risk group based on that data. This aspect of the disclosure stems from the realization that insurance loss in fields such as automobile, worker's compensation, and medical malpractice depend on the behavior of the individual. For example, automobile accidents occur because of how drivers behave on the road as determined by their personality or character traits, not because they are married men or single women. A disadvantage with using conventional criteria such as age and gender is that such criteria are only secondary characteristics that are merely correlated to accident frequency but do not cause of accidents. Personality or character traits, however, do determine on-the-road behavior and, hence, accident frequency.

Preferably, the data regarding the personality traits of the prospective insured is collected by administering a questionnaire that includes a number of survey statement with which the prospective insured indicates his agreement or disagreement. Even though the responses are subjectively reported, they are input into an objective scoring system in which, for example, a number of particular answers (such as an agreement) is counted. In particular, the following four survey statements are employed in one version of the questionnaire as highly predictive of claim reporting:

“I don't find it particularly difficult to get along with loud mouthed, obnoxious people”;

“In comparison to others my age, I have a less than average chance of having a heart attack”;

“I usually think carefully before doing anything”; and

“In comparison to others my age, I have less than average chance of being fired from ajob.”

It is contemplated that a different combination of one or more of these or other questions may be more appropriate for the particular context in which the questions are supplied, depending, for example, on the field and market for the insurance as well as the format and medium of the test. Therefore another aspect of the disclosure relates a survey methodology for formulating the questionnaire to discover additional ways of risk classification based on personality traits. In accordance with this methodology, data is collected from a sample of survey respondents, including: (a) an indication of a number of claims reported by each survey respondent and (b) a number of personality traits said each of the survey respondent. Then, sets of the personality traits are collected with the number of claims and selected if a correlation with the number of claims is greater than a correlation of traditional variables (such as age, gender, annual mileage, and driving experience) with the number of claims. Stemming from the realization that the relationship between event involvement and loss reporting is not one-to-one, the number of claims is used as the dependent variable because an insured who has an accident becomes less profitable if the event is actually reported.

Additional objects, advantages, and novel features of the present disclosure will be set forth in part in the description that follows, and in part, will become apparent upon examination or may be learned by practice of the disclosure. The objects and advantages of the disclosure may be realized and obtained by means of the instrumentalities and combinations particularly pointed out in the appended claims.

### BRIEF DESCRIPTION OF THE DRAWINGS

The present disclosure is illustrated by way of example, and not by way of limitation, in the figures of the accompanying drawings in which like reference numerals refer to similar elements and in which:

FIG. 1 is a flowchart of a methodology for devising a survey in accordance with one aspect of the present disclosure.

FIG. 2(a) is a bar chart showing a distribution of response patterns to a set of four survey questions.

FIG. 2(b) is a bar chart showing distribution of the percentage of drivers who made a claim in the past six years per driver class.

FIG. 3 is a flowchart of a risk classification methodology according to one embodiment of the present disclosure.

FIG. 4 is a block diagram of a computer system that can be used to implement the present disclosure.

FIG. 5 is a flowchart outlining an anti-gaming methodology according to one embodiment of the present disclosure.

### DESCRIPTION OF THE PREFERRED EMBODIMENT

A method, software, and apparatus for risk classification and survey formulation are described. In the following description, for the purposes of explanation, numerous specific details are set forth in order to provide a thorough understanding of the present disclosure. It will be apparent, however, to one skilled in the art that the present disclosure may be practiced without these specific details. In other instances, well-known structures and devices are shown in block diagram form in order to avoid unnecessarily obscuring the present disclosure.

Conventional risk classification and underwriting models are based on secondary characteristics such as age and gender, which are variables that are somewhat correlated to accident frequency and fairly inexpensive to collect. Using such secondary characteristics only crudely and inefficiently divides drivers into groups whose premium correspond to costs, because gender and age, for example, correlate with accident frequency but do not cause accidents by themselves.

One aspect of the present disclosure stems from the realization that, since automobile accidents happen because of those behavioral variables, such as personality traits, that determine the way a person drives, not because the driver happens to be male or happens to single. That is, the personality traits that determine driver behavior should be taken into account.

A “personality trait”, by definition, is a susceptibility to certain states of mind and an inclination to certain kinds of behavior. That is, while there is a relationship between personality traits and behavior, these concepts are as distinctly different as a cause (or a contributing factor) is to an effect (or a result). Accordingly, any overt behavior, such as taking part in avocations or performing habitual behavior, smoking cigarettes, drinking alcohol, abusing drugs, etc. is not a “personality trait” as defined herein.

Similarly, it is well recognized in the psychological arts that “personality traits” are distinctively different concepts from mood disorders, such as depression. That is, it is recognized in the field of psychology that mood disorders and other forms of mental illness are not forms of personality traits, and for the purpose of this discussion, the term “personality trait” specifically excludes mood disorders and other forms of mental illness.

However, while mood disorders are different concepts from personality traits, it is recognized that susceptibility to mood disorders are influenced by personality traits, but in the manner that a particular outcome results from a contributing factor. For example, a person may be “more likely to become depressed and slower to recover” from depression based on his/her personality type. Further information as to the nature of personality traits can be found in “DYSTHYMIA AND OTHER MOOD DISORDERS”, The Harvard Mental Health Letter, Vol.7, #11 (May 1991) and Icek Ajzen, Attitudes Personality and Behavior, Chap 1 “Attitudes and Personality Traits”, Open University Press (1988) both herein incorporated by reference in their entirety.

Accordingly, behavioral variables relating to personality traits and other personality or psychological characteristics of a prospective insured can be measured and used to classify the prospective insured into an appropriate risk group. This methodology need not be a replacement for conventional risk classification technique but can be used in combination therewith. One way to measure these personality traits is to give the prospective insured a questionnaire with personal statements with which the prospective insured is asked to indicate an agreement or disagreement.

In one embodiment, the selection of the particular personality traits is made so as produce a statistically significant greater prediction of insurance loss than that associated with only the conventional variables, such as age, gender, marital status, etc. The selection of the personality traits can be made by surveying a sample population.

Another aspect of the present disclosure stems from the realization that insurance losses are borne not just because accidents occur, but because the accidents are also reported. Such a tendency to report (or fail to report) an accident can also be influenced by an individual's personality traits, as well as by various aspects of the individual's character, such as honesty, morality, etc (collectively “character traits”).

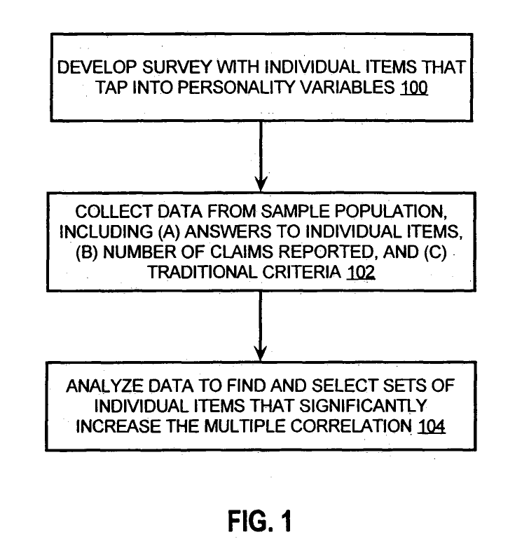

In accordance with one embodiment of the disclosure, a methodology for devising the questionnaire is illustrated in FIG. 1. At step 100, a survey is drafted with about 50 individual items that tap into personality traits that may affect accident involvement and reporting. These and similar items can be obtained by a review of the literature investigating personality and accident involvement, including journals such as Accident Analysis and Prevention and the Journal of Safety Research as well as resources such as the “psychlit” server, which is an extensive database of psychological journals and their articles. Based on such a review, a number of personality traits believed to be significantly predictive of automobile accident involvement are identified, such as (a) impulsivity, (b) locus of control, (c) self-esteem, (d) invulnerability, (e) hostility, (f) anger, (g) trust, (h) social desirability, and (i) thoroughness in decision making.

While the above-listed personality traits have been discussed in the context of predicting driving behavior and likelihood of predicting an accident, it should be appreciated that, in various embodiments, personality traits of various sorts can additionally be applied to other forms of risk assessment, such as worker's compensation and malpractice insurance of a medical professional.

It has been recognized in Joao et al. (U.S. Pat. No. 5,961,332) that certain personality-related data can be used to diagnose existing mental illnesses and prescribe appropriate treatment, and that such data relating to known, existing mental illnesses and therapy can be made available “for actuarial purposes for the payers of mental health insurance.” However, Joao does not utilize any form of personality trait data to predict whether an apparently healthy individual may later develop a mood disorder or other mental illness, much less to predict the likelihood of future claims involvement by an automobile driver as does the present invention.

Returning to FIG. 1, exemplary individual items, wherein a person is to indicate a disagreement, agreement, or neither, can include items such as:

1. “I often do and say things without stopping to think.”

2. “All in all, I am inclined to feel a failure.”

3. “I am able to do things as well as most other people.”

4. “I am not really in control of the outcomes in my life.”

5. “I am the victim of circumstances beyond my control.”

6. “I can think of no good reason for hitting anyone.”

7. “I don't find it particularly difficult to get along with loud mouthed, obnoxious people.”

8. “I find it hard to understand people who risk necks just to experience a ‘rush’.”

9. “I find that luck plays a bigger role in my life than my ability.”

10. “I get so ‘carried away’ by new ideas that I never think of possible snags.”

At step 102, the survey with the various individual items is given to a sample population, which can include, for example, undergraduate students, participants in safety conferences and workshops, employees from a local distribution center, or any randomly sampled group, of people of a desired demographics.

A careful review of the above items reveals that they have a subjective nature to them in that they touch on individual bias, rather than touch on particular extrinsic objects or people. As a result, such type of items tend to be more universal in their application. For example, the statement “I am able to do things as well as most other people” can universally be applied to practically everyone, wherein statements such as “I am able to do things as well as my brother/father” cannot be applied to large segments of society, e.g., single children/orphans. For the purpose of this discussion, such questions can be described as “universal-subjective” in nature and it should be appreciated that, in various embodiments, the questionnaires of the present disclosure can use any mix of universal-subjective and other types of statements without departing from the spirit and scope of the present disclosure.

The information collected from the survey participants includes answers to the various individual items in the form “strongly agree,” “agree”, “neither agree nor disagree”, “disagree,” and “strongly disagree.” In addition, the survey participants are asked to provide information relating to the number of accident claims that they have reported. Finally, the survey participants are also asked to provide information regarding conventional classification variables, such as age, marital status, years of driving experience, and number of miles driven per year.

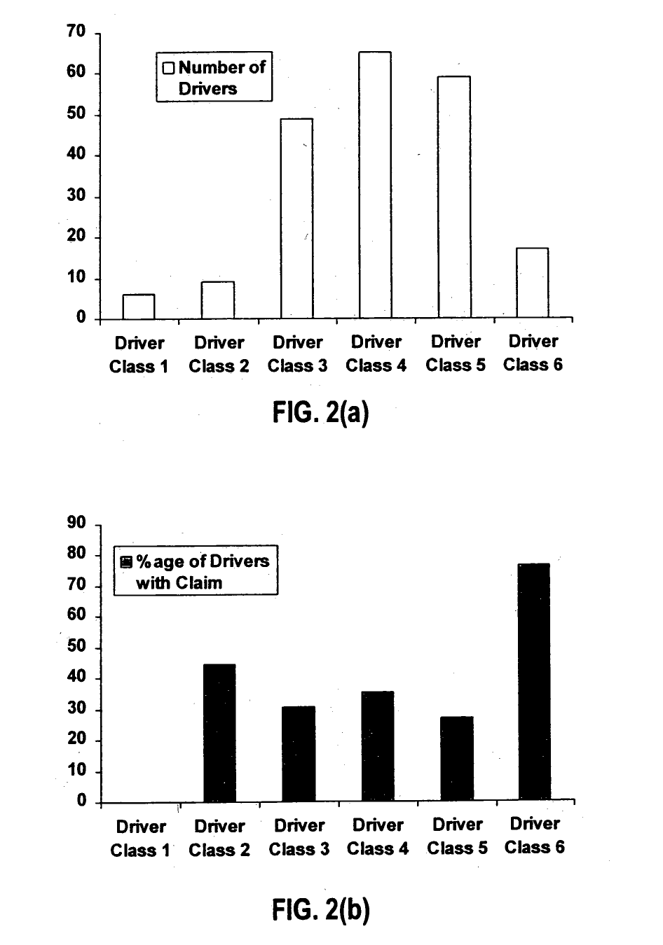

At step 104, the survey data is analyzed to determine a set of individual items whose answers significantly predict the number of claims made. FIGS. 2(a) and 2(b) relate to the results of one survey that was made with a total of 208 participants. Of this group, 92 were identifiably male and 109 were identifiably female. The age of the participants ranged from 16 to 77 and had a mean of 36.7. The miles driven per year ranged from 0 to 75,000 with a mean of 15,700, and the driving experience averaged 20.7 years in a range of 1 to 45 years. In this sample, the average number of claims reported were 0.43 claims over the past six years, with 71 of the participants having reported a claim over the six year period.

With this survey, the conventional variables of age, gender, annual mileage, and driving experience were subjected to a regression analysis with the number of claims as the criterion variable, i.e., the number of claims reported. These conventional variables together correlated with the criterion variable at 0.22 and therefore accounts for 4.7% of the variance. In other words, the use of conventional variables has been found to be a fairly crude and inefficient predictor of claim reporting.

Controlling for the conventional variables, the individual scores on the set of personality measures were then analyzed to find a group of items that significantly increase the multiple correlation. In this survey, data relating to four of the individual survey questions, however, were found to be useful in increasing the multiple correlation with the criterion variable to 0.49, which accounts for 24% of the variance. This fivefold increase in the predictive power is found significant at the 5% level. These four survey statements were:

“I don't find it particularly difficult to get along with loud mouthed, obnoxious people”;

“In comparison to others my age, I have a less than average chance of having a heart attack”;

“I usually think carefully before doing anything”; and

“In comparison to others my age, I have less than average chance of being fired from a job.”

FIG. 2(a) is a bar chart of the distribution of the response pattern to the four statements, in which the driver class is determined by the number of the four survey statements with which the participants agreed. Driver class 1 consists of 6 individuals who disagreed With all four items; driver class 2 consists of 9 people who did not agree with any of the items; driver class 3 included 49 participants who agreed with only one of the statements; driver class 4 comprises the 65 people who agreed with exactly two of the questions; driver class 5 has 59 individuals who agreed with exactly three of the items; and the 17 people of driver class 6 agreed with all four of the survey statements.

FIG. 2(b) is a bar chart showing the percentage of drivers in each driver class (defined by the number of statements that the survey participants agreed with as above) who has reported claims. Driver class 1 had 0% making claims; driver class 2 had 44.4%; driver class 3 with 30.6%; driver class 4 with 35.3%; driver class 5 with 27.1%; and driver class 6 with 76.5%.

A Chi-square analysis is also applied to the data as a test of dependence to determine if the criterion variable (the number of claims) is dependent on levels of the number of agreements with the four statements. In this survey, the Pearson's Chi-square was calculated to be 18.5, which with 5 degrees of freedom is significant well below the 5% level (p −0.00235). Finally, an analysis of variance is conducted to compare the means for the six different classes, in order to address the concern that the mean frequency of reported automobile accidents is the same for all drivers, regardless of driving class assigned. In this survey, the analysis of variance clearly indicates that the number of driving accidents reported over a six-year period is statistically higher for drivers in driver class 6 than for drivers in other classes.

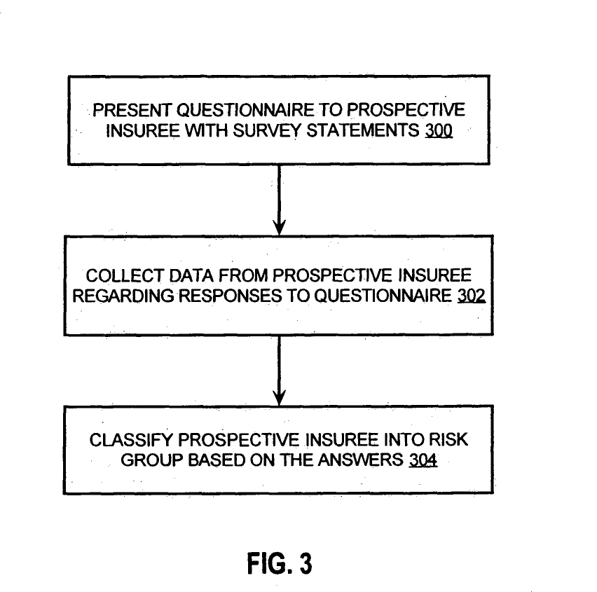

FIG. 3 is a flowchart illustrating how the results of this survey are used to classify the risk of prospective insureds. At step 300, a questionnaire is presented to a prospective insured that includes at least one of, and preferably all four, of the significant survey statements. These four statements can be included in a list of many other statements. The questionnaire itself can be presented by a variety of means such as by a computer configured to present a user interface locally or over the Internet for asking the questions, but the present disclosure is not limited to any particular means of presenting the questionnaire and may include giving the questionnaire on paper.

At step 302, the responses of the prospective insured are collected as data. Generally, the responses are collected in a technological manner appropriate for the means by which the questionnaire was presented. For example, a computer configured to present the survey statements on the questionnaire would also be configured to input and store the responses. Manually filled out paper questionnaires may be used with a data entry step for the responses.

At step 304, the prospective insured is classified into a risk group based on the answers to the survey statements. For example, the prospective insured would be placed into a high risk group if the prospective insured agrees with all four of the significantly correlated survey statements. Other risk groups can be based on a lower number of agreements with the four survey questions or with other survey questions. Even though the responses are subjectively reported, an objective evaluation processes the particular answers such as by counting the number of agreements. Once the prospective insured has been classified into a particular risk group, standard underwriting techniques are applied to determine the cost of the risk group and, hence, an appropriate insurance rate to charge the prospective insured.

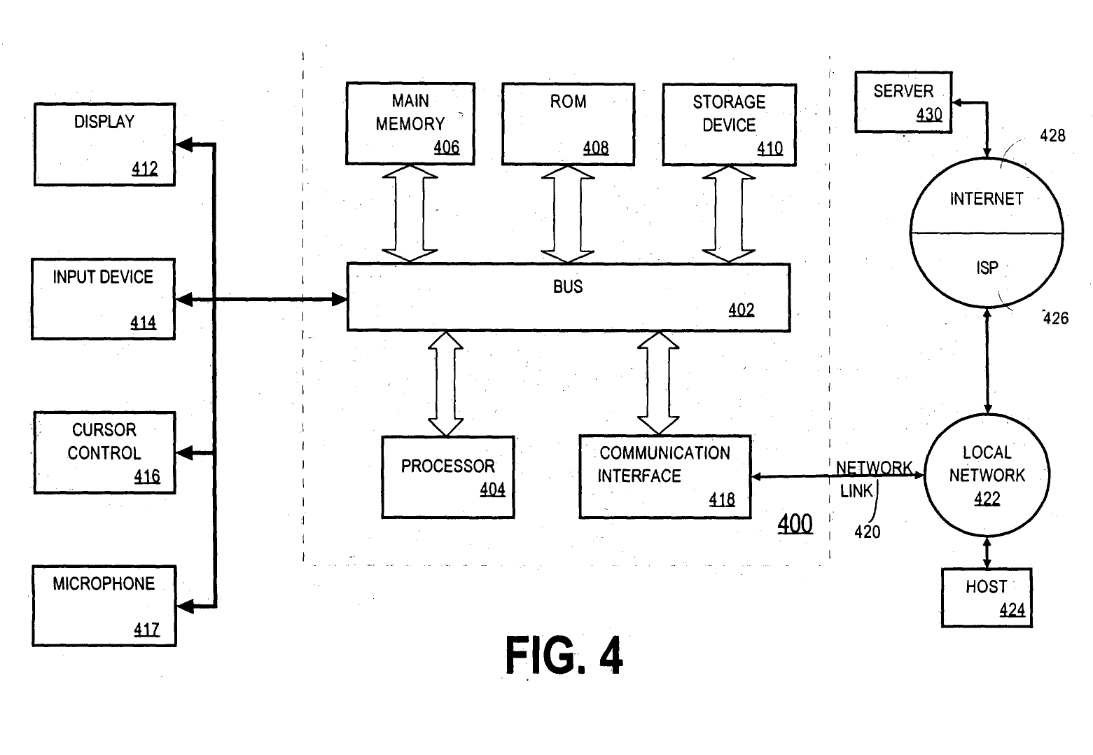

Various embodiments of the present disclosure may be implemented on a computer. FIG. 4 is a block diagram that illustrates a computer system 400 upon which an embodiment of the disclosure may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The disclosure is related to the use of computer system 400 for risk classification and survey formulation. According to one embodiment of the disclosure, risk classification and survey formulation is provided by computer system 400 in response to processor 404 executing one or more sequences of one or more instructions contained in main memory 406. Such instructions may be read into main memory 406 from another computer-readable medium, such as storage device 410. Execution of the sequences of instructions contained in main memory 406 causes processor 404 to perform the process steps described herein. One or more processors in a multi-processing arrangement may also be employed to execute the sequences of instructions contained in main memory 406. In alternative embodiments, hard-wired circuitry may be used in place of or in combination with software instructions to implement the disclosure. Thus, embodiments of the disclosure are not limited to any specific combination of hardware circuitry and software.

The term “computer-readable medium” as used herein refers to any medium that participates in providing instructions to processor 404 for execution. Such a medium may take many forms, including but not limited to non-volatile media, volatile media, and transmission media. Non-volatile media include, for example, optical or magnetic disks, such as storage device 410. Volatile media include dynamic memory, such as main memory 406. Transmission media include coaxial cables, copper wire and fiber optics, including the wires that comprise bus 402. Transmission media can also take the form of acoustic or light waves, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 404 for execution. For example, the instructions may initially be borne on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector coupled to bus 402 can receive the data carried in the infrared signal and place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network, now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 440 might transmit a requested code for an application program through Internet 428, ISP 426, local network 422 and communication interface 418. In accordance with the disclosure, one such downloaded application provides for risk classification and survey formulation as described herein. The received code may be executed by processor 404 as it is received, and/or stored in storage device 410, or other non-volatile storage for later execution. In this manner, computer system 400 may obtain application code in the form of a carrier wave.

While the questionnaires of the various embodiments show distinct advantage in assessing insurance risks based on behavioral variables, such as personality traits, it should be appreciated that various individuals may “fake” or “game” such questionnaires in manners that will seek to mislead an insurer. That is, it is recognized that individuals may not answer a questionnaire accurately for a number of reasons.

For instance, it is recognized that some people may not express their true opinion on an issue in order to appear more socially desirable. By example, some people may answer “strongly agree” to the statement “If I found even a small amount of money on a public sidewalk in an unmarked envelope, I would turn the money over to the police” in the belief that such behavior is socially desirable, while the reality of such circumstances make it unlikely that someone would take the effort to turn over a few dollars as a matter of practicality, rather than honesty. Such answers, while possible truthful in a small minority of individuals, more likely indicate either a tendency for one to sublimate truth in order to appear more socially desirable, a likelihood to “oversell” oneself, an indication of distorted self-awareness or some other behavioral characteristic that might cause one to intentionally or unintentional give misleading responses.

Gaming is an intentional/deliberate form of faking that is based on the idea that once an individual becomes aware that her answers to a questionnaire may affect her insurance rates, that individual has a financial incentive to provide answers designed to lower insurance rates, rather than provide accurate behavioral information. For example, an individual prone to anger may respond dishonestly to a statement about her temper in order to secure a lower insurance rate under the belief that better anger management leads to better insurance rates.

In order to counter such questionnaire “faking”, psychologists have developed a number of anti-faking/anti-gaming techniques. These techniques usually center around designing “built-in” anti-faking tools, which can incorporate such strategies such as: (1) carefully crafting statements directed to personality traits while embedding anti-faking “flags”, (2) using multiple questions designed to measure a particular trait, (3) using questions designed to measure the likelihood that an individual is honest, i.e., possesses the character traits of honesty, moral development, and so on (while optionally applying anti-faking techniques to these types of statements), (4) using a number of test variants containing different questions, (5) administering multiple test, (6) indicating that a subsequent interview concerning a questionnaire is likely, (7) administering follow-up interviews, especially when potential “flags” are raised by various answers, (8) monitoring the continued viability of a particular questionnaire in light of widespread gaming and (9) monitoring the continued viability of a particular question in light of widespread gaming. The techniques that are viable for and adaptable to the present invention are discussed at greater length below. When discussing anti-faking, it should be appreciated that generally anti-faking techniques are built-in to the questionnaires themselves or built-in to procedures for administering questionnaires. Accordingly, verifying techniques that require extrinsic data, such as a police report, a report independently generated by a psychologist or driving record, are not anti-faking tools.

(1) Embedding Anti-Faking Flags

As shown by example above, i.e., the “If I found even a small amount of money on a public sidewalk” statement scenario, it is possible to craft questions that raise flags in the event of appearing over-answered or otherwise indicate a highly unlikely, if socially desirable, extreme of a personality trait. Such crafting techniques are well-known in the art of psychology (although completely absent in conventional insurance questionnaires) and shall not be discussed further in great detail. However, further information about built-in anti-faking questions can be found in David J. Cherrington and J. Owen Cherrington, “Understanding Honesty”, The CHC Forecast (September 1993) herein incorporated by reference in its entirety.

(2) Incorporating Multiple Questions Directed to a Particular Trait

While a single flagged response is unlikely to reliably gauge a personality trait across a large population, it has been shown that examining various aspects of a particular trait and/or examining the same trait aspect using multiple questions can greatly increase the trait measurement accuracy or likelihood of detecting faking. For example, the Cherrington article mentioned above demonstrates that honesty can measured by gauging the responses to the various aspects of personal honesty, honesty of others, blame for dishonesty, punishment, definitions and standards of honesty, moral reasoning and past behavior. Consistent answers will provide accuracy; incongruent answers will indicate faking. Similarly, issues relating to personality traits, such as thoroughness of decision making, can be broken down into various facets and examined for accuracy and faking.

Further, various statements designed to measure the same trait should provide consistent results given no faking. If the statements are carefully crafted, prospective insureds having a tendency to fake will be flagged. For example, by carefully crafting two statements designed to measure a particular personality trait, e.g., confidence, with one statement in apparent tension with a “socially desirable” response, incongruous answers may raise a faking flag. By illustration, if a prospective insured answers “strongly agree” to the statement “Most of my peers view me as highly confident”, but answers “strongly disagree” to the statement “My confidence tends to make me look arrogant to some of my friends”, a faking flag might be raised as the prospective insured appears to excessively value socially desirable answers.

By further example, a particular questionnaire may contain five separate items related to measuring “aggressiveness”. Accordingly, it is to be expected that an individual having a particular level of aggressive tendencies will answer the different items in a consistent manner, while gamers will be more likely to answer inconsistently, i.e., slip up.

(3) Adding Questions Designed to Measure Honesty

The strategy behind this approach is to gauge whether an individual is likely to have answered truthfully and accurately based on an indication as to whether the individual is likely to lie, steal or otherwise engage in like behavior. By measuring what an individual would consider immoral, the individual's standards of behavior, the individual's motivations relating to moral compliance, the individual's tendency for remorse and so on, a general profile of the individual's tendency for providing honest answers can be determined. Assuming that answers to character trait statements (for which anti-faking techniques can also be applied), indicate a high-level of honesty or moral turpitude, an insurer may use this information for at least two purposes.

First, indications of high-levels of honesty may indicate that an individual is less likely to break various laws, including excessive use of alcohol, illicit use of drugs, driving under the influence of drugs or alcohol, speeding, intentionally running a red light and so on. As these factors often contribute to accidents, it can be surmised that a questionnaire directed to character traits, such as honesty and moral development, can be used to predict behavior that, in turn, will influence the likelihood of accidents. Similarly, such character traits may influence a medical professional's performance, an individual's likelihood of having an accident on the job, an employer's likelihood of maintaining an unsafe workplace that causes injuries and leads to claims for worker's compensation benefits, and so on.

Second, issues of character can reflect on an individual's likelihood of providing accurate responses to non-character related questionnaire statements. In this light, it should be appreciated that questions directed to character can be useful to determine insurance rates in an indirect fashion even if character issues were not per se good indicators of driving habits and other insurance-relevant behavior.

(4) Crafting a Number of Tests

This technique can be useful to discourage gaming as it will create conditions where individuals may find it too difficult to adequately prepare for all possible known statements collected from previously administered questionnaires or other collected from other sources. Even individuals possessing a high level of intelligence would be discouraged over the prospect of possibly spending days in preparation for what might be a de minimus economic return.

(5) Administering Multiple Test

Initially administering multiple test over a short period, or periodically reexamining an individual, can provide an effective anti-faking/anti-gaming tool. As character and personality traits should not vary significantly over time for a given individual, it should be appreciated that administering multiple questionnaires is likely provide improved accuracy for honest test-takers while flagging various inconsistencies for fakers/gamers.

(6) Indicating That a Subsequent Interview is Likely

This approach encourages honesty by implying that a potential prospective insured may be responsible for explaining her answers at a later point in time.

(7) Administering Follow-Up Interviews

This approach is useful to either resolve possible misunderstandings, or for “flushing out” intentionally or unintentionally faked responses.

(8) Continually Monitoring the Viability of a Particular Questionnaire

As a particular questionnaire is used over time, the likelihood that questionnaire “gamers” might come in possession of such a questionnaire increases, especially given the information resources made available via the internet. However, a substantial increase in gaming might be detected by monitoring the responses to a particular questionnaire over time. That is, as the responses to a given questionnaire should remain essentially constant for a large population over time, any statistical deviation indicating increased numbers of “safe drivers” might infer that excessive numbers of prospective insureds are in possession of the questionnaire and, ergo, the questionnaire has exceeded its useful life.

(9) Continually Monitoring the Viability of a Particular Question

The rationale behind this strategy is essentially the same for monitoring the viability of a particular questionnaire.

It should be appreciated that the various approaches listed above are but a limited subset of the possibilities available to psychologist in measuring accuracy of questionnaire responses. Accordingly, the terms “anti-faking” and “anti-gaming” should not be construed to imply only the limited list of approaches above, but can include any-known or later-developed techniques deemed useful for monitoring the likelihood of accurate responses to questionnaires.

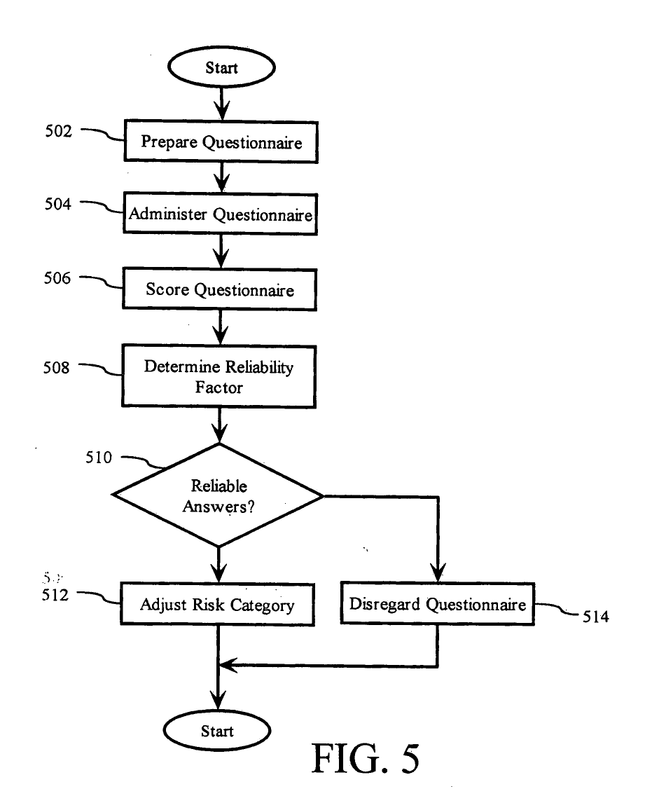

FIG. 5 is a flowchart outlining an anti-gaming methodology according to one embodiment of the present disclosure, applied to insurance questionnaires in accord with the current disclosure. The process starts at step 502, where one or more questionnaires suitable for measuring personality traits and using anti-faking (or anti-gaming) techniques is prepared. In various embodiments, such questionnaires will include the anti-faking/anti-gaming techniques discussed above as well as any other known or later developed technique deemed useful to prevent anti-faking/anti-gaming without departing from the spirit and scope of the present disclosure. The process continues to step 504.

In step 504, the questionnaire is administered to an individual for insurance categorization purposes. Next, in step 506, the completed questionnaire is scored to determine the behavioral variables, such as personality and character traits, for the individual completing the questionnaire. The process continues to step 508.

In step 508, the completed questionnaire is analyzed to determine whether the test-taking individual “faked” or “gamed” the questionnaire, and a “reliability factor”, which is a measure of confidence that the questionnaire was accurately and/or honestly answered, is determined. While the exemplary technique determines reliability factors based on the anti-faking techniques discussed above (including the use of multiple test in step 506) it should be appreciated that, as various anti-faking techniques are developed and/or adapted over time, the methodology used to create reliability factors, as well as the nature of reliability factors, may evolve commensurately. Accordingly, any form of data useable to determine questionnaire reliability factors, e.g., faking flags, may be used without departing from the spirit and scope of the present disclosure. The process continues to step 510.

In step 510, a determination is made as to whether the reliability factor of step 508 is sufficient to determine whether the questionnaire answers (and measured behavioral variables) are likely reliable. If the answers are deemed reliable, control continues to step 512 where the individual's risk category is adjusted based on his measured behavioral variables; otherwise, control jumps to step 514 where the questionnaire results are disregarded. The process then continues to step 520 where the process stops.

While this disclosure has been described in connection with what is presently considered to be the most practical and preferred embodiment, it is to be understood that the disclosure is not limited to the disclosed embodiment, but on the contrary, is intended to cover various modifications and equivalent arrangements included within the spirit and scope of the appended claims.

For example, the disclosed risk assessment methodology may be applied to lines of insurance other than automobile insurance, such as worker's compensation, medical malpractice, or other lines of insurance in which personality traits that determine the behavior of the insured affect the incidence of insurance loss.

What is claimed is:

1. A method for risk classification of a prospective insured, said method comprising:
accessing data regarding one or more personality traits of the prospective insured to develop personality trait data; and
classifying the prospective insured into one of a plurality of risk groups based on the personality trait data of the prospective insured;
wherein the risk classification relates to at least one of automobile insurance, insurance covering malpractice of a medical professional and worker's compensation insurance.

2. The method of claim 1, wherein the risk classification relates to automobile insurance.

3. The method of claim 1, wherein the risk classification relates to malpractice of a medical professional.

4. The method of claim 1, wherein the risk classification relates to worker's compensation insurance.

5. The method of claim 1, wherein the personality traits relate at least to one of (a) impulsivity, (b) locus of control, (c) self-esteem, (d) invulnerability, (e) hostility, (f) anger, (g) trust, (h) social desirability, and (i) thoroughness in decision making.

6. The method of claim 2, wherein classifying the prospective insured further includes consideration of one or more variables selected from a group consisting of age, gender, annual mileage, and driving experience.

7. The method of claim 1, further comprising calculating an insurance rate for the prospective insured based on the risk group into which the prospective insured was classified.

8. The method of claim 1, further comprising collecting the data regarding the personality traits of the prospective insured from the prospective insured.

9. The method of claim 8, wherein collecting the personality trait data includes administering a questionnaire to the prospective insured and recording replies provided by the prospective insured in response to one or more survey statements on the questionnaire.

10. The method of claim 1, further comprising:
accessing data regarding one or more character traits of the prospective insured to develop character trait data; and
classifying the prospective insured into one of the plurality of risk groups based on the character trait data of the prospective insured.

11. A method of risk classification for automobile insurance, said method comprising:
accessing data regarding answers provided by a driver to one or more survey statements selected from a group consisting of, for example:
“I don't find it particularly difficult to get along with loud mouthed, obnoxious people”;
“In comparison to others my age, I have a less than average chance of having a heart attack”;
“I usually think carefully before doing anything”; and
“In comparison to others my age, I have a less than average chance of being fired from a job.”

12. A method of risk classification for a driver, said method comprising:
accessing data regarding answers provided by the driver to one or more survey statements selected from a group consisting of, for example:
“I don't find it particularly difficult to get along with loud mouthed, obnoxious people”;
“In comparison to others my age, I have a less than average chance of having a heart attack”;
“I usually think carefully before doing anything”; and
“In comparison to others my age, I have less than average chance of being fired from a job”; and
classifying the driver into one of a plurality of risk groups based on the data regarding the answers.

13. A method of devising a questionnaire for use in risk assessment of a prospective insured, said method comprising:
collecting data from a plurality of survey respondents, said data including an indication of a number of claims reported by each of the survey respondents and a plurality of personality traits for said each of the survey respondents;
correlating sets of the personality traits with the number of claims; and
selecting one or more traits among the set of personality traits based on a correlation with the number of claims;
wherein the risk classification relates to at least one of automobile insurance,
insurance covering malpractice of a medical professional and worker's compensation insurance.

14. A method for risk classification of a prospective insured, said method comprising:
accessing data regarding one or more personality traits of the prospective insured to develop personality trait data; and
classifying the prospective insured into one of a plurality of risk groups based on the personality trait data of the prospective insured;
wherein the personality traits relate at least to one of (a) impulsivity, (b) locus of control, (c) self-esteem, (d) invulnerability, (e) hostility, (f) anger, (g) trust, (h) social desirability, and (i) thoroughness in decision making; and
wherein the risk classification relates to at least one of accident insurance and a likelihood of filing an accident insurance claim.

15. The method of claim 14, wherein the risk classification relates to accident insurance.

16. The method of claim 14, wherein the risk classification relates to a likelihood of filing an insurance claim.

17. A computer-readable medium bearing instructions for risk assessment of a prospective insured, wherein said instructions are arranged, when executed by one or more processors, to cause the one or more processors to perform the steps of:
accessing data regarding personality traits of the prospective insured; and
classifying the prospective insured into one of a plurality of risk groups based on the accessed data regarding the personality traits of the prospective insured;
wherein the risk classification relates to at least one of automobile insurance, insurance covering malpractice of a medical professional and worker's compensation insurance.

18. A method for risk classification of a prospective insured, said method comprising:
accessing data regarding one or more personality traits of the prospective insured to develop personality trait data; and
classifying the prospective insured into one of a plurality of risk groups based on the personality trait data of the prospective insured;
wherein the personality traits relate to at least one of locus of control, hostility, social desirability, and thoroughness in decision making.

19. The method of claim 18, wherein the personality traits relate to at least two of locus of control, hostility, social desirability, and thoroughness in decision making.

20. The method of claim 19, wherein the personality traits relate to at least three of locus of control, hostility, social desirability, and thoroughness in decision making.

21. A method for risk classification of a prospective insured, said method comprising:
accessing answers to a number of items, the items regarding one or more personality traits of the prospective insured, to develop personality trait data;
applying an anti-faking technique to the item answers to determine a reliability factor of the personality trait data; and
classifying the prospective insured into one of a plurality of risk groups based on the personality trait data of the prospective insured and the reliability factor.

22. The method of claim 21, wherein the risk classification relates to at least one of automobile insurance, insurance covering malpractice of a medical professional and worker's compensation insurance.

23. The method of claim 21, wherein the reliability factor is derived by at least one of (1) using one or more personality trait items that embed anti-faking measures, (2) using multiple personality trait items designed to measure a particular trait, (3) using one or more personality trait items designed to measure the likelihood that an individual is honest, (4) using multiple questionnaire variants each containing different combinations of personality trait items, (5) administering multiple questionnaires containing personality trait items to a prospective insured, (6) indicating to a prospective insured that a subsequent interview concerning a questionnaire is likely, (7) administering follow-up interviews to a prospective insured if a reliability flag is raised by an answer of a prospective insured, (8) monitoring the continued viability of a particular questionnaire in and (9) monitoring the continued viability of a particular item.

24. A method for risk classification of a prospective insured, said method comprising:
accessing data regarding one or more character traits of the prospective insured to develop character trait data; and
classifying the prospective insured into one of a plurality of risk groups based on the character trait data of the prospective insured.

25. The method of claim 24, wherein the character traits relate at least to one of (a) honesty, and (b) moral development.

25. The method of claim 24, wherein the risk classification relates to at least one of automobile insurance, insurance covering malpractice of a medical professional and worker's compensation insurance.

26. The method of claim 25, wherein the risk classification relates to at least one of automobile insurance, insurance covering malpractice of a medical professional and worker's compensation insurance.
